(19) United States
(12) Patent Application Publication
(10) Pub. No.: US 2013/0119023 A1
(43) Pub. Date: May 16, 2013

(54) GRAPHITIZED EDM WIRE

(71) Applicants: Dandridge Tomalin, Mason, OH (US); Larry Shilling, Dover, OH (US)

(72) Inventors: Dandridge Tomalin, Mason, OH (US); Larry Shilling, Dover, OH (US)

(21) Appl. No.: 13/810,962

(22) PCT Filed: Jul. 22, 2011
(86) PCT No.: PCT/US11/44986

§ 371 Date: Jan. 18, 2013

Related U.S. Application Data
(60) Provisional application No. 61/366,963, filed on Jul. 23, 2010.
(60) Provisional application No. 61/496,639, filed on Jun. 14, 2011.

(51) Int. Cl. B23H 1/04; B23H 1/06

(52) U.S. Cl. CPC B23H 1/04; B23H 1/06
USPC 219/69.12; 29/825

(57) ABSTRACT

An electrode wire for use in an electrical discharge machining apparatus includes a core having a surface and one of a metal, an alloy of a metal, and a combination of a metal and alloy of a metal. An adherent coating of graphite is metallurgically bonded to the surface of the core.

### RELATED APPLICATIONS

This application claims priority to U.S. Provisional Application No. 61/366,963, filed Jul. 23, 2010; U.S. Provisional Application No. 61/298,706, filed Jan. 27, 2010; and U.S. Provisional Application No. 61/496,639, filed Jun. 14, 2011, the entirety of which are incorporated herein by reference.

### TECHNICAL FIELD

The present invention relates to electrical discharge machining (EDM) and, more specifically, relates to an electrode wire to be used in discharge machining and to the process for manufacturing an EDM electrode wire having a layer that includes graphite metallurgically bonded to the wire core.

### BACKGROUND

The process of electrical discharge machining (EDM) is well known. In the field of traveling wire EDM, an electrical potential, i.e., voltage, is established between a continuously moving EDM wire electrode and an electrically conductive workpiece. The potential is raised to a level at which a discharge is created between the EDM wire electrode and the workpiece. The intense heat generated by the discharge melts and/or vaporizes a portion of both the workpiece and the wire to thereby remove, in a very small increment, a piece of the workpiece. By generating a large number of such discharges a large number of increments are removed from the workpiece whereby the workpiece can be cut very exactly to have a desired planar contour. A dielectric fluid is used to establish the necessary electrical conditions to initiate the discharge and to flush debris from the active machining area.

The residue resulting from the melting and/or vaporization of a small increment or volume of the surface of both the workpiece and the EDM wire electrode is contained in a gaseous envelope constituting plasma. The plasma eventually collapses under the pressure of the dielectric fluid. The liquid and the vapor phases created by the melting and/or vaporization of material are quenched by the dielectric fluid to form solid debris. The cutting process therefore involves repeatedly forming plasma and quenching that plasma. This process occurs sequentially at nanosecond intervals and at many spots along the length of the EDM wire.

It is important for flushing to be efficient because inefficient flushing result in conductive particles being built up in the gap, which can create the potential for electrical arcs. Arcs are very undesirable as they cause the transfer of a large amount of energy, which causes large gouges or craters, i.e., metallurgical flaws, to be introduced into the workpiece and the EDM wire electrode. Such flaws in the wire could cause the EDM wire to break catastrophically.

An EDM wire should posses a tensile strength that exceeds a desired threshold value to avoid tensile failure of the wire electrode induced by the preload tension that is applied. The EDM wire should also possess a high fracture toughness to avoid catastrophic failure induced by the flaws caused by the discharge process. Fracture toughness is a measure of the resistance of a material to flaws which may be introduced into the material and that can potentially grow to a critical size to potentially cause catastrophic failure of the material. The desired threshold tensile strength for and EDM wire electrode is thought to be in the range 60,000 to 90,000 psi.

It is known in the prior art to use an EDM wire electrode with a core composed of a material having a relatively high mechanical strength with a relatively thin metallic coating covering the core. The EDM wire typically includes at least 50% of a metal having a low volumetric heat of sublimation such as zinc, cadmium, tin, lead, antimony, bismuth or an alloy thereof. Such a structure is disclosed is U.S. Pat. No. 4,287,404 which discloses a wire having a steel core with a coating of copper or silver which is then plated with a coating of zinc or other suitable metal having a low volumetric heat of sublimation.

It is also known from the prior art, for instance from U.S. Pat. No. 4,686,153, to coat a copper clad steel wire with zinc and thereafter to heat the zinc coated wire to cause inter-diffusion between the copper and zinc to thereby convert the zinc layer into a copper zinc alloy. That patent describes the desirability of a beta phase alloy layer for EDM purposes. The copper zinc has a concentration of zinc of about 45% by weight with the concentration of zinc decreasing radially inward from the outer surface. The average concentration of zinc in the copper zinc layer is less than 50% by weight but not less than 10% by weight. The surface layer therefore includes beta phase copper-zinc alloy material at the outer surface since beta phase copper zinc alloy material has a concentration of zinc ranging between 40%-50% by weight. While this patent recognized that a copper-zinc alloy layer formed by means of a diffusion anneal process could potentially contain epsilon phase (approximately 80% zinc content), gamma phase (approximately 65% zinc content), beta phase (approximately 45% zinc content), and alpha phase (approximately 35% zinc content), the patent asserts that the preferred alloy material is beta phase in the coating.

Others in the prior art, for instance U.S. Pat. No. 5,762,726, recognized that the higher zinc content phases in the copper-zinc system, specifically gamma phase, would be more desirable for EDM wire electrodes, but the inability to cope with the brittleness of these phases limits the commercial feasibility of manufacturing such wire. This situation changed with the technology disclosed in U.S. Pat. No. 5,945,010. By employing low temperature diffusion anneals, the inventor was able to incorporate brittle gamma phase particles in a coating on various copper containing metallic substrates. However, epsilon phase was found to be too unstable to be incorporated in the resultant high zinc alloy coating, although the potential for brittle epsilon coatings was acknowledged.

The desirability of incorporating graphite in coatings has been previously recognized since graphite has long been known to be a very efficient electrode material in “sinking” EDM where cavities are formed replicating the shape of chosen electrodes. The first example, and to this date the only commercially successful example of incorporating graphite in a wire coating, is described in U.S. Pat. No. 4,717,804 where “black” molybdenum or tungsten wire produced by the classical refractory metal wire drawing process, as described in the text “Tungsten” by C. J. Smithells, Chapman, and Hall (1952), was used to produce an EDM wire with superior performance. Molybdenum is a very unique metal which possesses certain properties which are only duplicated in its “sister” element tungsten. Most notable among these properties is the fact they both form adherent oxides which are porous and characterized by a very low vapor pressure. Early researchers found that these porous oxides provided an excellent foundation for an adherent graphite coating since the porosity provided additional surface area for entrapping the coating compared to the smooth surface of the bare metal. Since drawing refractory metals must be performed at elevated temperatures, the graphite/oxide coating provided an excellent lubricating system. The fact that the oxides possess a very low vapor pressure further benefits their use as an EDM electrode as this property enhances the flushing characteristics of the wire.

The challenge of incorporating graphite into other EDM wire systems is that of figuring out how to adhere the graphite to the wire. In U.S. Pat. No. 4,740,666 Tomalin and Capp described a process for graphitizing modified forms of ferrous alloy metal core wires, such as “Dumet” or “Cumet” (commercial copper clad products of the General Electric Company). For these wires, samples were prepared by thermally oxidizing the copper clad wire by conventional means followed by coating the oxidized wire with a carbon lubricant surface coating, and finally reducing the wire diameter as described by the black refractory metal process, only at room temperature rather than an elevated temperature. This approach, however, was only marginally successful for an obvious reason. More specifically, unlike the porous adherent oxides formed on tungsten and molybdenum, copper forms a dense adherent oxide. The porous adherent oxides provide an optimum surface for developing an adherent coating due to its increased surface area. In the case of a dense copper oxide coating, the oxide may well be adherent, but the lack of porosity requires the graphite coating to lay on top of the oxide and therefore it cannot be captured by the oxide and is subject to being “peeled” off the surface.

Other inventors, for example those listed in U.S. Pat. No. 5,030,818, have suggested incorporating unrealistically large volume fractions of graphite, e.g., up to 40 weight percent graphite, into a molten bath of copper or brass and “solidify(ing) into wire with a diameter of about 0.002 to about 0.014 inches.” Such a large volume of graphite, however, could never be uniformly dispersed in a molten bath of copper or brass due to the large density difference between graphite and metals. Graphite has a density that is only 25% that of copper, which results in the graphite particles floating on the surface of the melt. Even if the graphite could be uniformly incorporated into the melt, the suggestion that wires of diameters ranging between 0.002 and 0.014 inches could be continuously cast is unrealistic. Others, for example those listed in U.S. Pat. No. 6,447,930, have suggested graphite particles could be “intercalated”, i.e., inserted or introduced, in metallic coatings without any suggestion as to how graphite or other “inert hard phases” could be “intercalated”.

Additional methods of employing graphite into brass wires have also been described. As disclosed in U.S. Patent Publication 2007/0295695, attempts have been made to infiltrate a porous epsilon phase coated wire with graphite by drawing the coated wire in a lubricant composed of a suspension of fine graphite particles in an aqueous solution. This method of applying graphite to an epsilon phase brass coating, however, is unsuccessful because no adhesion is formed between the graphite and the epsilon phase brass and, thus, the graphite coating is not adequately secured to the coating.

The reasons why graphite particles encapsulated in the coating of a wire electrode for wire EDM would increase cutting performance are not specifically known. It has been suggested that other hard inert particles incorporated into coatings will enhance the erosion resistance of the coatings, but one would not expect graphite to function similarly because it is not known to have significant erosion resistance. Graphite, however, does have another property which may be more valuable to the EDM application. The products of oxidation of graphite—carbon monoxide and carbon dioxide—are gaseous and since the conditions in the gap of the EDM process, e.g., elevated temperature and high partial pressure of oxygen, favor oxidation it would seem likely that most of the graphite on a wire electrode would be oxidized. Therefore graphite would contribute very little solid “debris” resulting from the discharge events that constitute the metal removal process. By way of contrast, metal coatings generate discrete particulate matter as the plasma envelope collapses under the pressure of the dielectric flush. Simply stated, there is no solid debris to flush from graphite whereas metal coatings generate conductive solid particulate which must be removed to avoid generating arcing and the resultant wire breakage. The issue with both hard inert particles and graphite is adequately adhering the discrete particles on and into the coating.

Based on the foregoing, there is a need in the art for an EDM wire that is coated with graphite while maintaining advantageous metallurgical properties. More specifically, there is a need in the art for a thin wire EDM that is effectively coated with graphite. The object of this invention is to identify a technique whereby graphite particles can be metallurgically bonded, (e.g., diffusion or chemically bonded, the metallic or alloy surface of an EDM wire. This objective is achieved, as regards the process, by the means of the features of the present invention.

### SUMMARY OF THE INVENTION

In one embodiment of the present invention, a modified slip casting procedure is performed to metallurgically or chemically bond an EDM wire to a graphite coating. The procedure employs a slurry of zinc powder, organic binder, colloidal graphite, and a suspension medium such as isopropyl alcohol. A wire substrate with a chemically cleaned surface at an intermediate diameter is drawn through the slurry and dried. The powder coated wire is then heat treated to remove any remaining suspension medium, cure the binder, and sinter the zinc powder, thereby encapsulating the intermixed graphite powder and forming metallurgical bonds between the core and the graphite coating. Subsequently, the wire is drawn to its finished diameter, preferably using a lubricant containing graphite particles.

In another embodiment of the present invention, an etched EDM wire is drawn at elevated temperatures using a powder graphite lubricant which also serves as the conduction medium by which the wire is heated to the elevated temperature. Successive reduction passes with the powder lubricant are taken at temperatures high enough to allow one or more of the chemical constituents of the surface to migrate into the graphite layer on the surface. The repeated reduction passes form microscopic chemical bonds between the migrating species and the wire surface. After a critical number of such bonds have been affected by repeated reductions, a metallurgical bond will exist between the resultant graphite coating and the wire surface. In order to facilitate the adherence of powder particles to the wire as it enters the wire drawing die, the wire is also flooded with an aqueous suspension of submicron graphite particles and binding agents prior to the wire entering the heating zone that precedes the wire drawing die holder. After multiple passes, a metallurgically bonded graphite layer will be formed that is adherent to the wire core and electrically conductive.

Other objects and advantages and a fuller understanding of the invention will be had from the following detailed description of the preferred embodiments and the accompanying drawings.

### BRIEF DESCRIPTION OF THE DRAWINGS

FIG. 1 is a schematic view of the components of a wire drawing and coating apparatus in accordance with an embodiment of the present invention;

FIG. 2 is a schematic illustration of a modified slip casting powder coat process in accordance with another embodiment of the present invention;

FIG. 3 is a microphotograph of a cross-section of a graphitized brass wire that is drawn using the process described in Example 1;

FIG. 4 is a graph illustrating the results of an EDAX analysis of the zinc and copper distributions across the coating on the surface of a wire produced by the process described in Example 1;

FIG. 5 illustrates a comparison of the surface structures of an uncoated brass wire (FIG. 5a) compared to a graphitized brass wire (FIG. 5b) after exposure to the EDM machining process using the same operating parameters;

FIG. 6 illustrates the topographical maps generated from a confocal microscope for the surface of uncoated brass (FIG. 6a) and wire produced by the process described in Example 1 (FIG. 6b) after exposure to the EDM machining process using the same operating parameters;

FIG. 7 is a microphotograph of a cross-section of the as drawn wire using the process described in Example 2;

FIG. 8 illustrates the results of an EDAX analysis of the nickel and carbon (graphite) distributions across the coating on the surface of a wire produced by the process described in Example 2.

FIG. 9 is a photograph illustrating the structure of a wire after a 550° C./30 minute sintering heat treatment using the powder coating process of FIG. 2;

FIG. 10 is a photograph illustrating the surface structure of a wire after drawing to an intermediate diameter using the powder coating process of FIG. 2;

FIG. 11 is a photograph illustrating the surface structure of a wire after drawing to a finish diameter using the powder coating process of FIG. 2; and

FIG. 12 is an optical photomicrograph of a cross-section of a powder coated wire drawn to a 0.25 mm finish diameter.

### DETAILED DESCRIPTION

The present invention relates to electrical discharge machining (EDM) and, more specifically, relates to an electrode wire to be used in discharge machining and to the process for manufacturing an EDM electrode wire having a layer that includes graphite metallurgically bonded to the wire core. Since graphite is a lubricant that has been successfully used in other wire drawing applications, one object of the present invention is to couple the proven efficiency of graphite as a lubricant with the ability of some species to migrate at elevated temperatures thereby allowing them to form metallurgical bonds in a process sometimes termed “diffusion bonding.” In the case of EDM wire, zinc is known to possess favorable properties that promote good flushing characteristics when used as a coating either in an unalloyed or an alloyed state due to its low volumetric heat of sublimation. In addition, zinc has a low melting point which enhances the ability of zinc to migrate into the coating, thereby allowing a diffusion bond to be developed. Therefore, if a zinc-coated wire is drawn at elevated temperature using a powdered graphite lubricant, a diffusion bonded coating of graphite is developed on the wire after repeated drawing passes.

One process for forming the graphitized wire of the present invention is illustrated in FIG. 1. A zinc coated brass wire (1) is first flooded with a commercially available, aqueous suspension of submicron graphite (2), e.g., Achesion Aqua Dag® or Fuchs 138. The composite wire is then fed into an electric resistance furnace (3) that is filled with submicron graphite powder (4). The furnace (3) heats the wire by conduction/convection.

The composite wire then enters a wire drawing die (5) where its diameter is reduced. Multiple passes of the composite wire through the drawing die (5) can be accomplished by looping the composite wire around a series of capstans as is conventionally done in multi-die wire drawing machines. Passing the heated composite wire through the drawing die (5) multiple times causes migration of the core zinc into the graphite coating, thereby forming diffusion bonds, i.e., metallurgical bonds, between the wire and the coating. This results in a graphite coating that is adherent and chemically bonded to the wire.

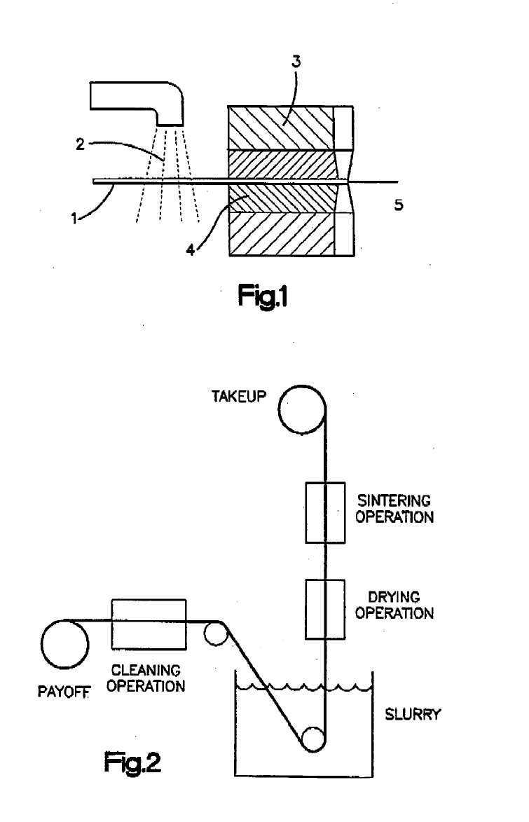

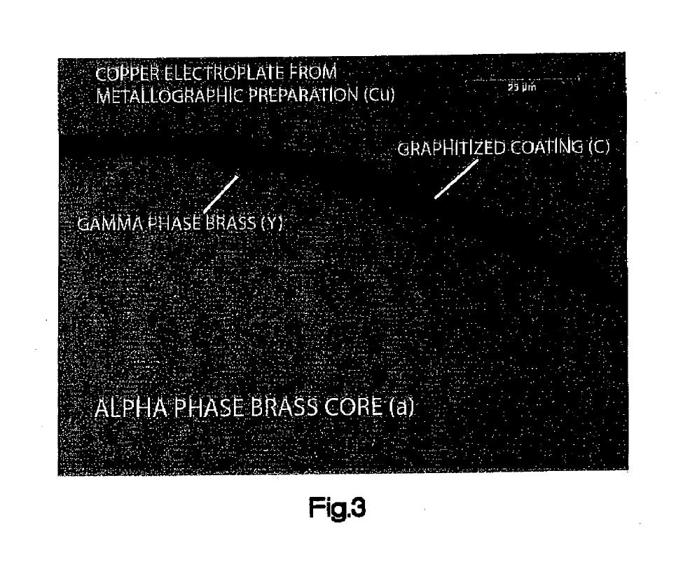

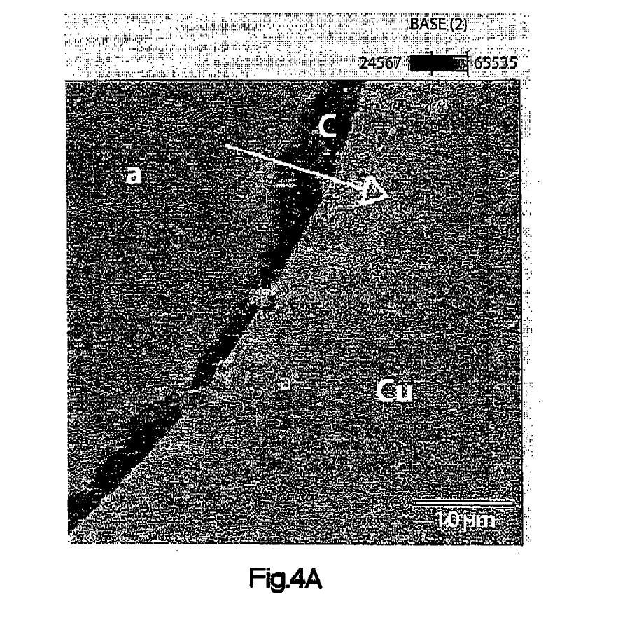

FIG. 2 illustrates a modified slip casting process in accordance with another aspect of the present invention. In the modified slip casting process a suspension of colloidal graphite and zinc powder forms a coating that results from drying a slurry cast onto the substrate wire. Subsequently, the coated wire is subjected to a sintering heat treatment to consolidate the coating and chemically or metallurgically bond graphite particulate to a zinc alloy coating, thereby metallurgically bonding the graphite particulate in the zinc alloy coating.

As shown in FIG. 2, a container of slurry (slip) is positioned to allow the substrate wire to be drawn through it to cast a symmetrical layer of the slurry onto the substrate. The composite structure is then dried and sintered to form a metallurgically bonded coating prior to being coiled onto a takeup. Once the coating has been deposited with the desired thickness, that coating can be converted to one or more of the brass alloy phases such as, for example, beta, gamma, and/or epsilon phase. The metallurgically bonded graphite particles enhance the performance of the wires with one or more of these brass alloy coatings in direct proportion to the volume fraction of graphite contained in the coating.

Although two processes for metallurgically bonding graphite to the wire EDM are described, it will be appreciated that the graphite could alternatively be electroplated onto the substrate wire. Furthermore, the graphite could be adhered to the substrate wire by, for example, introducing the wire into a fluid bed that includes zinc particles co-ball milled with graphite powder. The resultant wire includes a graphite coating chemically bonded to or mechanically encapsulated in the wire surface.

The graphitized wire produced by any of the aforementioned processes is advantageous for use in EDM applications. In particular, the products of oxidation of graphite are gaseous, i.e., carbon monoxide and carbon dioxide, and since the conditions in the gap of the EDM process favor oxidation, e.g., elevated temperature and high partial pressure of oxygen, it is likely that most of the graphite on a wire electrode would be oxidized. Therefore, graphite contributes very little solid “debris” resulting from the discharge events that constitute the metal removal process. By way of contrast, current metal coatings generate discrete particulate matter as the plasma envelope collapses under the pressure of the dielectric flush. In other words, the graphitized EDM wire of the present invention does not produce solid debris to flush from the graphite whereas current metal coatings generate conductive solid particulate which must be removed to avoid generating arcing and the resultant wire breakage. Accordingly, graphitized EDM wires have increased cutting performance compared to current metal coated wires by alleviating or minimizing the need to flush solid debris from the wire during use. Specific illustrations of the processes of the present invention are provided by the following examples.

### EXAMPLE 1

Core: 63Cu/37Zn

Galvanize 30 μm Zinc at 1.0 mm

Draw from 1 mm to 0.35 mm at 243° C. in the apparatus illustrated in FIG. 1

Draw from 0.35 mm to 0.25 mm at 218° C. in the apparatus illustrated in FIG. 1

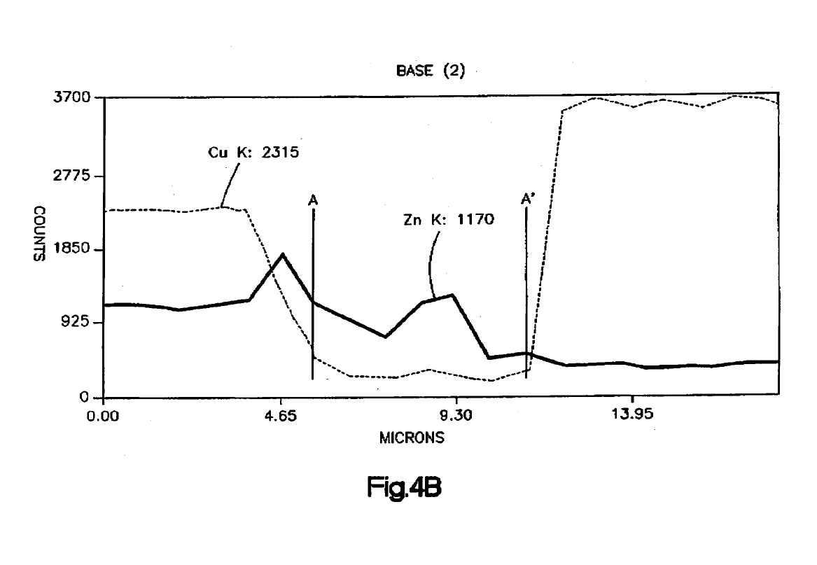

FIG. 3 illustrates an optical metallographic cross-section of the graphitized brass wire produced by the process described shown in Example 1 at its final diameter of 0.25 mm. Prior to cross-sectioning, a copper layer was electroplated on the wire so that the details of the coating structure could be preserved and not subjected to edge rounding. This coating is indicated as area “Cu” in the microstructure. The microstructure of the wire consists of an alpha phase brass core (Area “α”), an intermediate layer of gamma phase brass alloy (Area “γ”) formed by the diffusion of copper into the original zinc coating, and an outer layer of graphitized coating (Area “C”). The various areas have been identified so they can be related to the results of subsequent SEM analyses.

FIG. 4 illustrates the results of an Energy Dispersive X-Ray Analysis (EDAX) performed on a Scanning Electron Microscope (SEM) using the same sample that generated the previous FIG. 3. Although it is difficult to discern in reproduced photomicrographs, the gamma phase brass region y can be discerned in the original SEM photomicrograph due to its lighter shading relative to the outer layer of graphitized coating (C). It clearly manifests itself in the EDAX scan as evidenced by the spike in zinc content just prior to the region identified as A-A′ in FIG. 4. It is also clear that zinc has migrated into the graphitized region A-A′, thereby creating a metallurgical or chemical bond that binds the graphite layer developed during drawing to the substrate wire.

The performance of the graphitized brass wire of Example 1 was compared to the performance of uncoated brass wire of the same composition using an Agie DEM 250 Fast Track EDM machine under the conditions identified in Table I.

TABLE I

| | |
|---|---|
| Work Piece | |
| Material | D2 Tool Steel |
| Height | 2 inches |
| Flush Pressure | 180 psi (sealed nozzles) |
| Wire Tension | 1150 gms |
| Wire Speed | 135 mm/sec |
| Height Compensation | 5 |
| On Time | 1.15 |
| Frequency | 1.5 |
| Peak Current | 3 |
| Mode | 4 |
| Ignition Amplifier | 75% |
| % Feed | 90-100 |
| % Frequency | 100 |
| Average Current | 3.0 amps |

Under these identical operating conditions, the graphitized brass wire displayed a cutting speed of 4.0 inches/min compared to a 3.2 inches/min cutting speed for conventional uncoated brass wire. The fact that the graphitized brass wire cut 25% faster than the conventional uncoated brass wire at the same machine tool settings would suggest some change or changes occurred in the cutting mechanism.

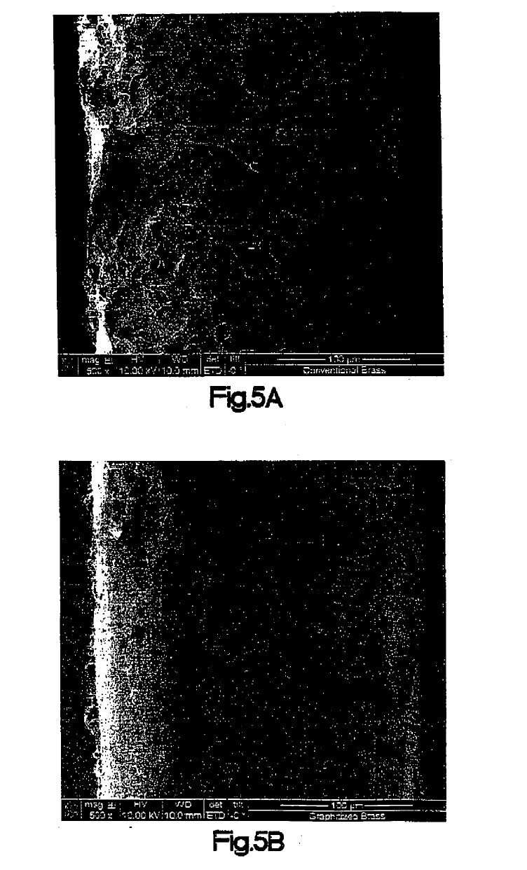

An examination of the wire surface after exiting from the EDM process suggests what one of those changes may be. FIG. 5 represents views of the surface morphology of both conventional uncoated brass (FIG. 5a) and graphitized brass (FIG. 5b) wires after exiting the machine tool. The conventional brass exhibits a very rough surface with deep craters where discharges have occurred, whereas the graphitized brass surface appears relatively smooth with only a few isolated craters. This conclusion is confirmed by a confocal optical microscopy analysis, which has the ability to quantify surface roughness.

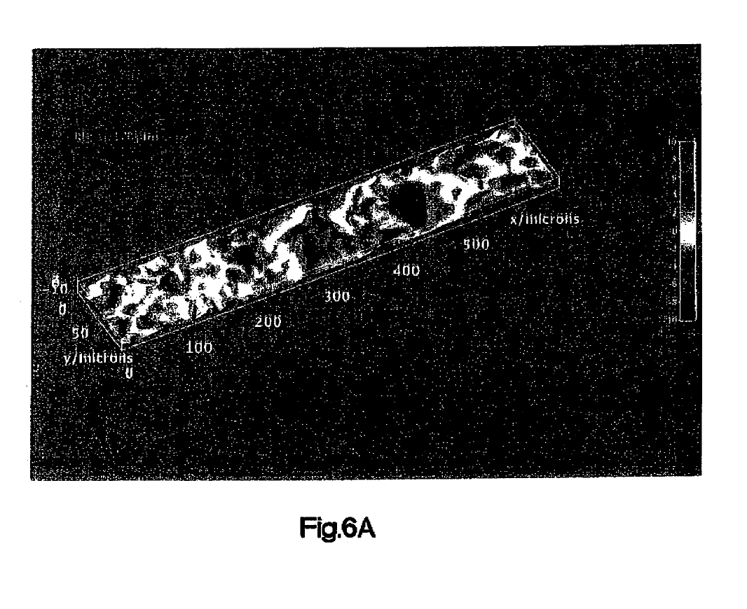

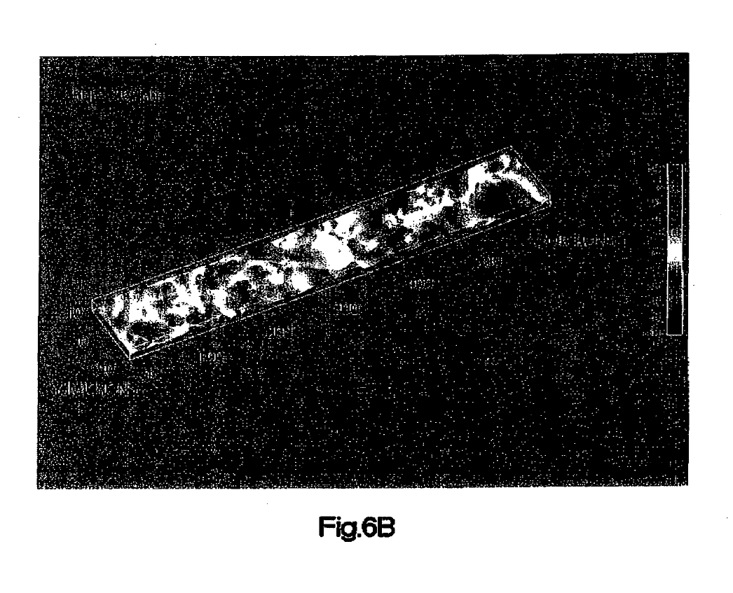

Samples of eroded wire of conventional brass and graphitized brass were examined on an Olympus Confocal Microscope, which uses a laser beam to scan the surface of the wire at a given height, store the data, scan the wire surface again at an incrementally lower height, and repeat that sequence multiple times. Software developed by Olympus allows one to integrate those planar scans into a topographical map such as the ones illustrated in FIG. 6a (conventional uncoated brass wire) and FIG. 6b (graphitized wire produced per process illustrated in Example 1). The software also has the ability to take a curved surface—such as that of a round wire—and flatten the surface into a planar view. It calculates a surface roughness parameter Rq to compare surface roughness where higher Rq values are indicative of a rougher surface. As evidenced by FIG. 6b, both the topographical maps and Rq factors of the conventional brass (FIG. 6a) and the graphitized brass (FIG. 6b) samples of eroded wire clearly indicate the graphitized brass has a smoother surface after erosion under identical machine tool parameters.

Elements other than zinc are also able to migrate at elevated wire drawing temperatures as illustrated by the product produced from the process illustrated in Example 2.

### EXAMPLE 2

Core: AISI 1006 carbon steel at 1.39 mm dia

Electroplate 28 μm of nickel

Cold Draw to 0.35 mm dia in water soluble lubricant

Etched in 50% diluted HNO₃ with 8% HF added and heated to 140° F. prior to being subjected to 36 VDC until gas evolution was observed

Warm Draw to 0.25 mm dia at 345° C. in the apparatus illustrated in FIG. 1

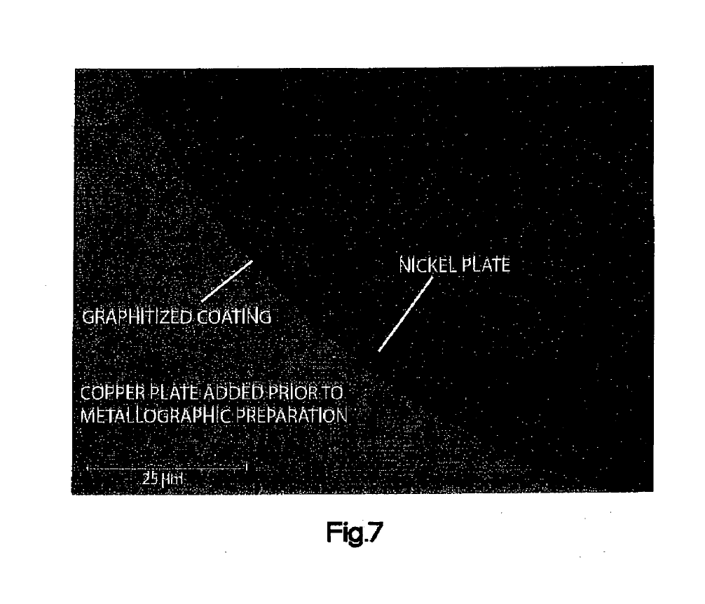

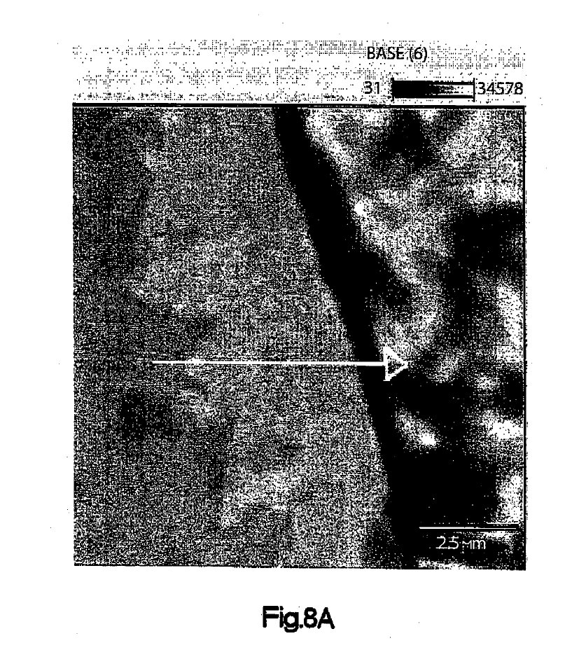

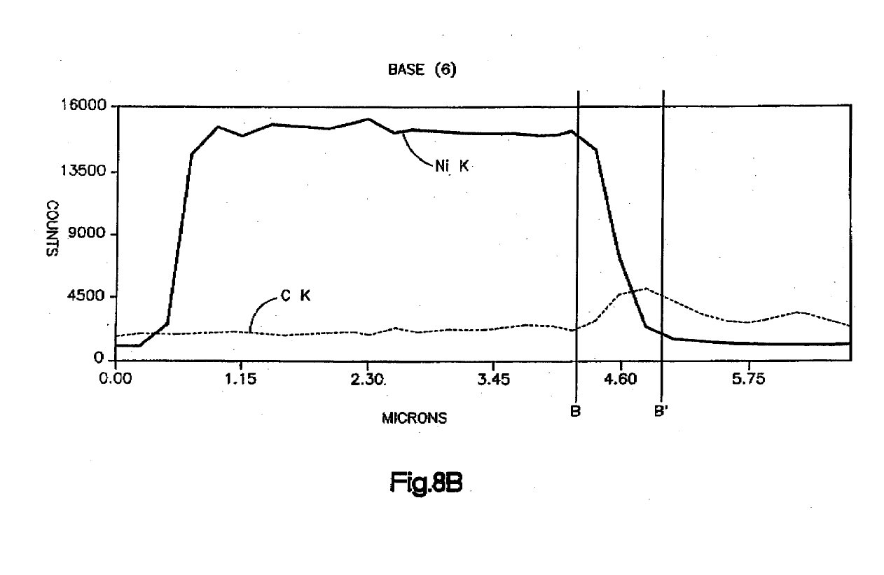

The warm drawing was performed in the same apparatus using the same drawing technique of Example 1. FIG. 7 illustrates an optical metallographic cross-section of the resultant wire. Prior to cross-sectioning, this sample was also electroplated with copper to preserve the details of the graphite layer. The graphite layer is thinner than that produced by the process in Example 1 because of the reduced total deformation during the exposure to graphite and heat. However, when the cross-section was analyzed with the EDAX apparatus in a SEM, it was found there was enough interaction between the graphite and substrate nickel electroplate to form a diffusion bond as illustrated by the data presented in FIG. 8. In the narrow region identified as B-B′ of FIG. 8, it can be seen that carbon (graphite) and nickel coexist which is the criteria for forming a diffusion bond.

### EXAMPLE 3

In the following example EDM wire was produced by the modified slip casting process of FIG. 2. A 63Cu37Zn brass alloy wire of 0.9 mm diameter was first cleaned by passing it through a hydrogen atmosphere furnace maintained at 500° C. The cleaned wire was then passed through a slurry composed of 90 gms of synthetic graphite powder (UFG-30, ≈10μ), 48.8 gms of Dag® 154 (proprietary suspension of colloidal graphite and organic binders in isopropyl alcohol manufactured by the Henkel Corporation, Madison Heights, Mich.), and 30 ml of isopropyl alcohol. The coated wire was dried in air and sintered in a controlled atmosphere furnace (N₂/5% H₂) at 550° C. for 30 minutes.

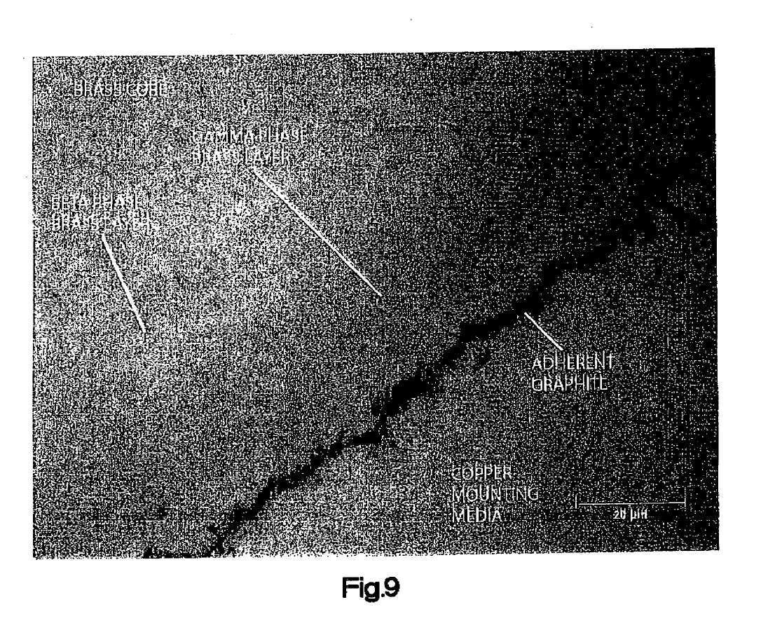

FIG. 9 illustrates the resultant microstructure. The heat treatment employed in this example produced a duplex microstructure of gamma and beta phase brass layers. As heat treated, the wire has a relatively smooth surface as evidenced by its microstructure. The sample was drawn to an intermediate diameter of 0.57 mm using graphite as the drawing lubricant. To accomplish the drawing, the wire was heated to 65° C. and immediately flooded with Aqua Dag® (proprietary aqueous suspension of colloidal graphite and organic binders manufactured by the Henkel Corporation) followed by heating to 370° C. to dry and cure the binder/graphite coating prior to being introduced into a dry wire drawing die. Multiple drawing passes of an approximate 20% reduction in area were repeated using the same technique herein described to reach the 0.57 mm diameter.

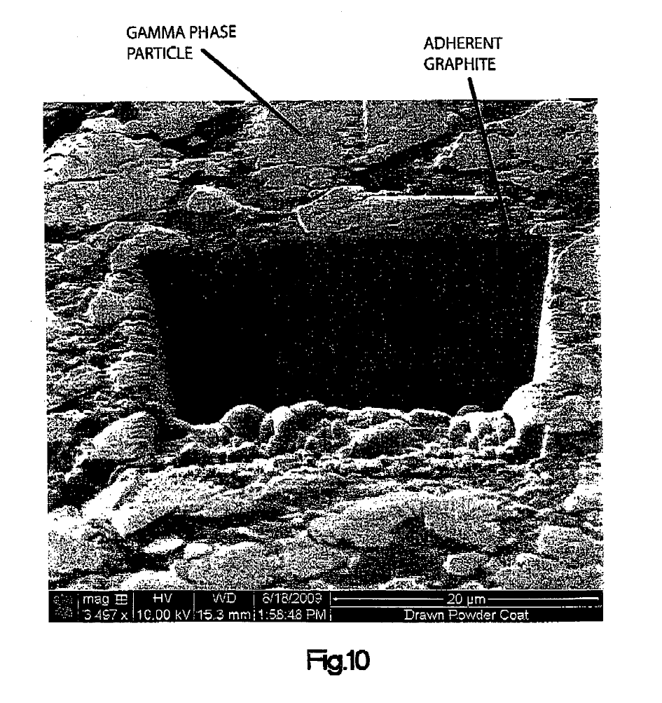

The brittle gamma phase coating fractured during drawing, which resulted in a roughened surface as illustrated in FIG. 10. The surface can be characterized as being composed of islands of gamma phase surrounded by regions of graphite, which are bonded to the core by the organic binders. The identity of these components was established by ion milling a slot in the surface and analyzing the various components using the EDAX capability of the SEM. In addition to these features, a thin film of graphite covered the entire gamma-phase surface.

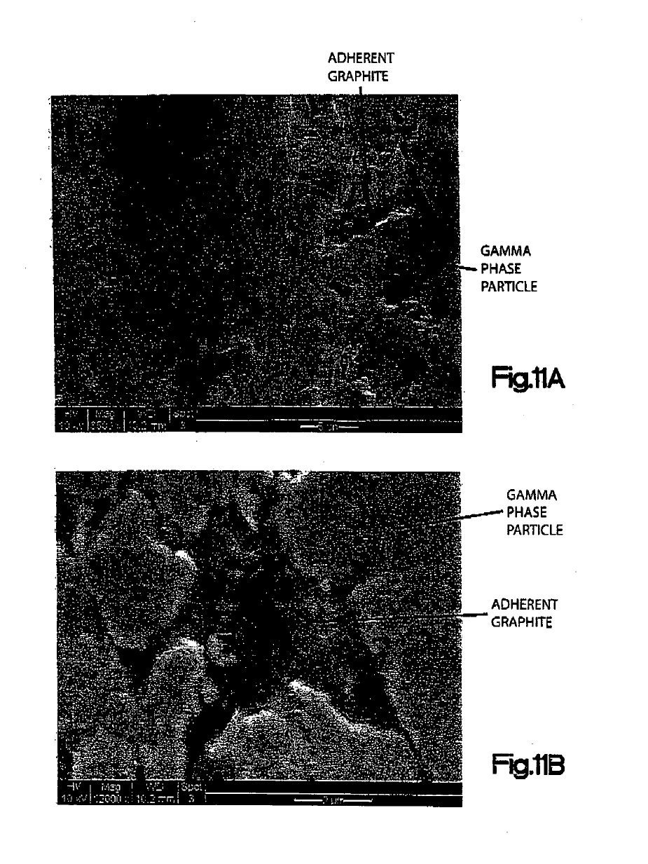

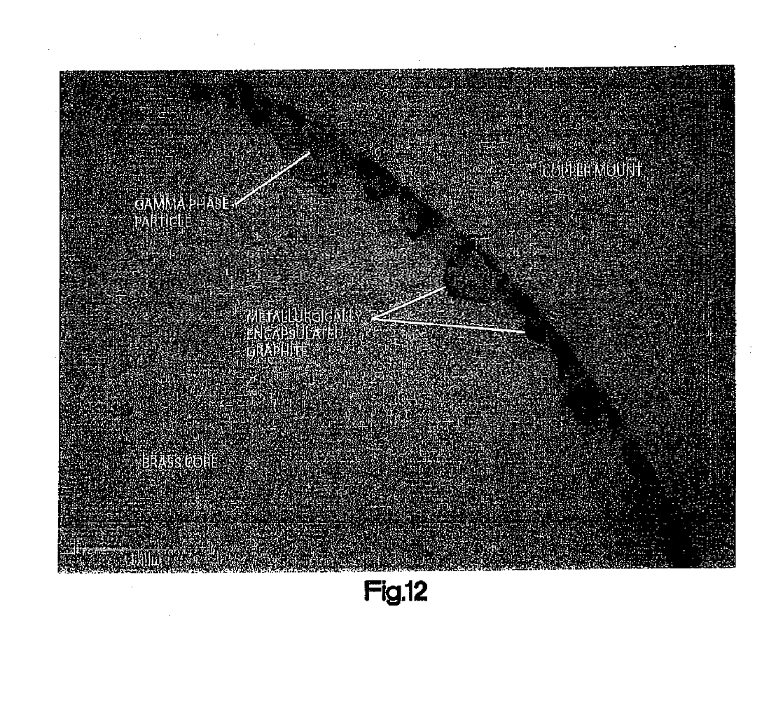

Using the drawing technique described above, the wire was drawn to a final diameter of 0.25 mm. FIG. 11 illustrates the surface of the resultant wire as viewed on the SEM and FIG. 12 illustrates a cross-section of the same wire using an optical microscope. The surface morphology is basically the same as that viewed at the intermediate diameter except the graphite regions occupy a smaller percentage of the total surface. In cross-section, however, it can be seen that, in addition to the graphite adherent on the surface, some of the graphite has been encapsulated below the surface beneath some of the gamma phase particles as well as buried in the core material. As was noted at the intermediate diameter, the entire surface was covered by a thin film of adherent graphite as evidenced by the dark sheen assumed by the wire.

We believe that the ability to encapsulate some of the graphite below the surface of the gamma phase particles was a direct result of the roughening of the surface as the gamma phase is fractured and redistributed on the surface. In other words, we believe that roughening the surface of the substrate wire facilitated metallurgic bonding and migration of the graphite into the underlying substrate layer by increasing the surface area and porosity of the underlying layer.

Although Example 3 illustrates that drawing the wire can roughen the surface sufficient to promote graphite encapsulation beneath the surface of the wire, other methods of surface roughening may be contemplated by those having ordinary skill. For example, the surface of a substrate wire may be roughened via mechanical or chemical etching, mechanical abrasion, or the like as was accomplished by the HNO₃/HF chemical etch utilized in Example 2. The outer surface of the substrate wire may also be roughened using other mechanical and/or chemical methods known to those with ordinary skill in the art.

Although the present examples illustrate the production of graphitized wire using gamma phase brass as a substrate wire, we believe that alternative substrate wire materials may used. For example, the processes of the present invention may be used to graphitize substrate wires formed from, for example, epsilon phase brass, beta phase brass, alpha phase brass, a high tensile strength ferrous material such as stainless steel, galvanized steel, a copper-based material such as brass-clad copper or copper-clad steel (including gamma phase), a zinc-based or zinc-clad material or other materials having a tensile strength in the range of about 60,000 to about 90,000 psi. Regardless of the substrate wire material used, we believe that it is desirable to roughen the outer surface of the substrate wire to promote incorporation and migration of the graphite layer therein.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

1. An electrode wire for use in an electrical discharge machining apparatus, the wire comprising:
a core having a surface and one of a metal, an alloy of a metal, and a combination of a metal and alloy of a metal; and
an adherent coating of graphite metallurgically bonded to the surface of the core.

2. The electrode wire of claim 1, wherein the graphite is chemically bonded to the core.

3. The electrode wire of claim 1, wherein the graphite is diffusion bonded to the substrate wire as evidenced by the migration of one or more elements from those present in the substrate into the graphite coating.

4. The electrode wire of claim 1, wherein the core comprises brass.

5. The electrode wire of claim 4, wherein the brass comprises zinc in the range of about 5% to about 40% by weight.

6. The electrode wire of claim 1, wherein the core comprises copper.

7. The electrode wire of claim 1, wherein the core comprises copper clad steel.

8. The electrode wire of claim 1, wherein the core comprises brass clad copper.

9. The electrode wire of claim 1, wherein the core comprises brass clad copper clad steel.

10. The electrode wire of claim 1, wherein the core comprises nickel plated stainless steel.

11. A process for manufacturing an electric discharge machining wire electrode, the process comprising:
providing a wire core comprising one of a first metal, an alloy of a first metal, and a composite structure of a first metal;
passing the core wire through a slurry of zinc and graphite powders suspended in a liquid medium with a dissolved binding agent to create a coated core wire;
drying the coated core wire to remove the liquid medium thereby creating a dried coated core wire;
sintering the dried coated core wire in a protective gaseous atmosphere in the temperature range of about 45° C. to about 750° C.;
cooling the coated core wire; and
drawing the coated core wire to a final diameter with the aid of a drawing lubricant.

12. A process for manufacturing an electric discharge machining wire electrode, the process comprising:
providing a wire core comprising one of a first metal, an alloy of a first metal, and a composite structure of a first metal;
preheating the core wire to a temperature in the range of about 40° C. to about 90° C.;
flooding the preheated core wire with a colloidal suspension comprised of graphite and organic binders;
curing the core wire coated with colloidal graphite and binders at a temperature within the range of about 200° C. to about 425° C.; and
drawing the core with a cured coating through a dry die at room temperature.

13. A process for manufacturing an electric discharge machining wire electrode, the process comprising:
(i) providing a wire core comprising one of a first metal, an alloy of a first metal, and a composite structure of a first metal;
(ii) heating the core to a temperature in the range of about 200° C. to about 400° C.;
(iii) introducing the heated core into a reservoir of graphite powder to form a composite wire;
(iv) reducing the diameter of the composite wire in a drawing die; and
(v) repeating steps (ii) and (iv) until the wire reaches its intended diameter.

14. The process of claim 13, further comprising repeating steps (ii) and (iv) such that the wire core migrates into the graphite layer to form metallurgical bonds between the wire core and the graphite layer.

15. The process of claim 13 further comprising roughening an outer surface of the wire core to promote metallurgical bonding between the graphite powder and wire core.

16. The electrode wire of claim 1, wherein the surface of the core has a roughened texture that promotes metallurgical bonding between the core and the graphite.

17. The process of claim 11, wherein sintering the dried coated core wire causes migration of one or more elements from those present in the core wire into the graphite layer.

18. The process of claim 11, wherein sintering the dried coated core wire metallurgically bonds the graphite powder to the core wire.

19. The process of claim 18 further comprising roughening an outer surface of the core wire to promote metallurgical bonding between the graphite powder and core wire.

20. The process of claim 12, wherein drawing the core with the cured coating metallurgically bonds the graphite to the wire core.

21. The process of claim 20 further comprising roughening an outer surface of the wire core to promote metallurgical bonding between the graphite and wire core.
